(19) United States
(12) Patent Application Publication
(10) Pub. No.: US 2025/0130355 A1
(43) Pub. Date: Apr. 24, 2025

(54) MULTI-LAYER DIELECTRIC COATINGS FOR HIGH-EFFICIENCY DIELECTRIC GRATINGS

(71) Applicant: II-VI Delaware, Inc., Wilmington, DE (US)

(72) Inventors: Justin Hannigan, Eugene, OR (US); Dmitri Iazikov, Eugene, OR (US); Christoph Greiner, Eugene, OR (US)

(21) Appl. No.: 18/382,370

(22) Filed: Oct. 20, 2023

Related U.S. Application Data
(60) Provisional application No. 63/432,504, filed on Dec. 14, 2022.

(51) Int. Cl. G02B 5/18; G02B 1/115

(52) U.S. Cl. CPC G02B 5/1866; G02B 1/115; G02B 2005/1804

(57) ABSTRACT

Systems and methods are provided for multi-layer dielectric coatings for high-efficiency dielectric gratings. A immersion grating based morphology includes a plurality of grating lines, an intermediate multi-layer structure, and a substrate bearing both of the plurality of grating lines and the intermediate multi-layer structure, with the intermediate multi-layer structure including a plurality of intermediate layers, and with the intermediate multi-layer structure configured to improve performance of the immersion grating based on predetermined performance criteria including, at least, reflective losses based performance. A transmission grating based morphology includes a plurality of grating lines, an intermediate multi-layer structure, and a substrate bearing both of the plurality of grating lines and the intermediate multi-layer structure, with the intermediate multi-layer structure including a plurality of intermediate layers, and with the intermediate multi-layer structure configured to improve performance of the transmission grating based on predetermined performance criteria including, at least, reflective losses based performance.

### TECHNICAL FIELD

Aspects of the present disclosure relate to optical communication based solutions. More specifically, certain implementations of the present disclosure relate to methods and systems for implementing and utilizing multi-layer dielectric coatings for high-efficiency dielectric gratings.

### BACKGROUND

Limitations and disadvantages of conventional diffraction gratings will become apparent to one of skill in the art, through comparison of such systems with some aspects of the present disclosure as set forth in the remainder of the present application with reference to the drawings.

### BRIEF SUMMARY

System and methods are provided for multi-layer dielectric coatings for high-efficiency dielectric gratings, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF THE DRAWINGS

FIG. 1 illustrates a cross-section of an example diffraction grating.

FIG. 2 illustrates an example immersion grating and use case scenario associated therewith.

FIG. 3 illustrates an example immersion grating morphology incorporating a multi-layer dielectric (MLD) structure.

FIG. 4 illustrates performance maps for an example immersion grating implemented without MLD.

FIG. 5 illustrates performance maps for an example immersion grating implemented with MLD.

FIG. 6 is a plot illustrating zero-order reflection (R₀) as a function of wavelength for example immersion gratings.

FIG. 7 is a plot illustrating first-order reflection (R₁) as a function of wavelength for example immersion gratings.

FIG. 8 is a plot illustrating zero-order reflection (R₀) as a function of incidence angle for example immersion gratings.

FIG. 9 is a plot illustrating first-order reflection (R₁) as a function of incidence angle for example immersion gratings.

FIG. 10 illustrates an example transmission grating and use case scenario associated therewith.

FIG. 11 illustrates an example transmission grating morphology incorporating a multi-layer dielectric (MLD) structure.

FIG. 12 illustrates performance maps for an example transmission grating implemented without MLD.

FIG. 13 illustrates performance maps for an example transmission grating implemented with MLD.

FIG. 14 is a plot illustrating zero-order transmittance (T₀) as a function of wavelength for example transmission gratings.

FIG. 15 is a plot illustrating first-order transmitted diffraction efficiency (T₁) as a function of wavelength for example transmission gratings.

FIG. 16 is a plot illustrating zero-order reflection (R₀) as a function of wavelength for example transmission gratings.

FIG. 17 is a plot illustrating first-order reflection (R₁) as a function of wavelength for example transmission gratings.

FIG. 18 is a plot illustrating total reflection (R) as a function of wavelength for example transmission gratings.

FIG. 19 is a plot illustrating zero-order reflection (R₀) as a function of incidence angle for example transmission gratings.

FIG. 20 is a plot illustrating first-order reflection (R₁) as a function of incidence angle for example transmission gratings.

FIG. 21 is a plot illustrating total reflection (R) as a function of incidence angle for example transmission gratings.

FIG. 22 is a plot illustrating zero-order transmittance (T₀) as a function of incidence angle for example transmission gratings.

FIG. 23 is a plot illustrating first-order transmitted diffraction efficiency (T₁) as a function of incidence angle for example transmission gratings.

FIG. 24 is a plot illustrating first-order transmitted diffraction efficiency (T₁) performance for example transmission gratings with MLD and without MLD.

FIG. 25 is a plot illustrating total reflectivity (R) performance for example transmission gratings with MLD and without MLD.

### DETAILED DESCRIPTION

The present disclosure is directed to diffraction gratings, and particularly to morphologies used therein. In this regard, a diffraction grating is an optical component having a periodic structure configured to resolve (e.g., angularly disperse) incident light, of varying wavelengths, into several beams travelling in different directions. Diffraction gratings may be used in different devices, systems, or the like, where use and control of optical beams (e.g., lasers) may be desired or needed. For example, diffraction gratings may be used in fiber optics based solutions. In this regard, optical fibers carrying multiple signal wavelengths may incorporate diffraction gratings for spectral multiplexing or demultiplexing. Solutions in accordance with the present disclosure provide enhanced diffraction gratings, and particularly enhanced grating based morphologies, as described in more detail below.

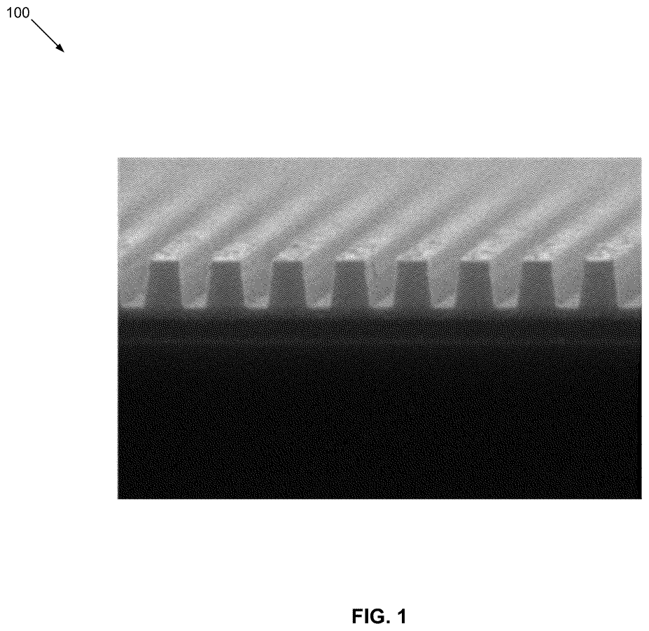

FIG. 1 illustrates a cross-section of an example diffraction grating. Shown in FIG. 1 is diffraction grating 100. The diffraction grating 100 comprises a surface with multiple lines and spaces, configured for facilitating grating functions. The diffraction grating 100 may be disposed on a substrate layer configured to bear the grating.

The diffraction grating 100 may have a repetitive structure comprised of, e.g., periodic lines and spaces—that is, close, equidistant, and parallel lines, separated by corresponding close, equidistant, and parallel spaces. In other words, the diffraction grating 100 may have lines of equal size, spaced by equal size spaces. Such repetitive structure, particularly when the material used therein is selected suitably, may resolve incident lights in a particular manner. Nonetheless, in some instances the grating lines may have aperiodic spacing (e.g., chirped gratings) and curvilinear contours. Different contours of different shape and/or variable spacing may still preserve grating function but add additional benefits of aberration control or modifying the incoming wavefront (e.g., focusing or collimation).

In various implementations based on the present disclosure, new morphologies may be used for manufacturable, high-performance diffraction gratings. Such morphologies may be used in different types of diffraction gratings, such as immersion gratings and transmission gratings. In this regard, transmission gratings (or transmissive gratings) are diffraction gratings typically used in transmission, and which operate to angularly disperse incident light into a spectrum. As used therein, the transmission gratings are phase gratings that modify the phase of incoming light (rather than amplitude gratings, which modify the amplitude of incoming light in periodic function), and as such may be theoretically up to 100% efficient. Immersion gratings are similar to transmission gratings in that they too modify the phase of incident light, but function in the regime of total internal reflection—that is, the incidence angle is larger than the critical angle at the interface containing the grating lines. Where immersion gratings are used, typically the light is incident on the grating surface from the inside of media supporting the grating lines.

Solutions based on the present disclosure may improve performance of diffraction gratings, while also addressing or mitigating some of the issues or limitations associated with conventional solutions. In this regard, one significant limiting factor in the performance of diffraction gratings is reflective losses. Reflections between the substrate and the grating structure can limit the amount of power delivered to the grating structure (e.g., when illuminated from the substrate side as in an immersion grating configuration). For transmission gratings, reflections between the grating structure and substrate limit transmissivity—e.g., the efficiency into the desired output order and lead to redistribution of power into other orders. As such, in either type, limiting the reflections at the interface may result in improved performance.

In solutions based on the present disclosure, an intermediate layer structure may be introduced/added between the grating structure and the substrate layer bearing the grating structure. The intermediate layer structure may be adaptively configured—that is, based on the selection of material used therein, arrangement thereof, etc.—for improving performance of the diffraction gratings, such as by providing anti-reflection behavior based on predetermined criteria. For example, the predetermined criteria may comprise achieving improvement by a particular percentage (e.g., 5%, 10%, etc.) with respect to particular performance aspect or parameters (e.g., reflective losses) compared to gratings having similar structure but without the intermediate layer structure. The intermediate layer structure offers additional benefits, in addition to the anti-reflection benefits, such as improved overlap functions (e.g., with respect to polarization components), as described in more detail below. The intermediate layer structure may comprise a multiple layers based arrangement. For example, in various implementations, the intermediate layer structure may comprise a multi-layer dielectric (MLD) based structure, adaptively configured for providing anti-reflection behavior as described herein. In this regard, in some instances the first layer of the MLD stack that is closest to the grating lines may beneficially act as an etch-stop layer, providing the functions and benefits attributed thereto as described in United States Patent Application Ser. Number __/___,___ (Attorney Docket No. 67055US06) filed on even date therewith, which is incorporated herein by reference in its entirety.

In various example embodiments, an improved grating morphology may be used, comprising, at least, 1) grating lines comprising one or more dielectric layers; 2) a multi-layer dielectric (MLD) structure or coating providing increased diffraction efficiency by impedance matching between the substrate and the grating-thus, improved anti-reflection behavior; and 3) a substrate bearing these layers/structures. Such morphology may provide various benefits, compared to conventional morphologies (if any exist), including, at least, 1) improved performance due to MLD structure configured to provide minimum reflectivity; and 2) improved overlap between ideal morphology for different polarization components (e.g., s-polarization and p-polarization components). Example embodiments, directed to immersion gratings and transmission gratings, are described in more detail below.

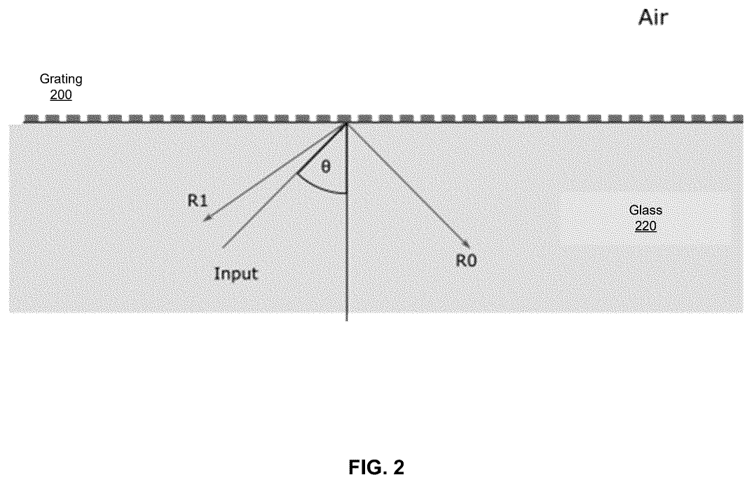

FIG. 2 illustrates an example immersion grating and use case scenario associated therewith. Shown in FIG. 2 is immersion grating 200 and use case scenario associated therewith, such as during grating operation using the immersion grating 200.

As illustrated, the immersion grating 200 comprises a grating structure, which comprises a repetitive structure having a surface with close, equidistant, and parallel lines, separated by corresponding close, equidistant, and parallel spaces, configured for resolving incident optical signals. The grating structure is disposed on top of material (e.g., glass) 220. Nonetheless, the disclosure is not limited to use of glass substrate, and any suitable material may be used. For example, any material that is transparent for the operational range of the grating may be used. Also illustrated in FIG. 2 is an example grating operation, using the immersion grating 200, with single propagating order. In this regard, an input beam (incident light) is applied onto the immersion grating 200, with the input beam striking the immersion grating 200 from the bottom side—that is, from within the material 220 (e.g., glass) under the grating structure, resulting in a number of corresponding outputs. Further, while the immersion grating 200 is illustrated as having air to the outside of it (above and external to the grating structure), the disclosure is not limited to such design, and in some example implementations instead of air, other gasses, liquids, or material meeting particular criteria (e.g., having lower refractive index than that of the grating layer and/or substrate material) may be used.

As shown in FIG. 2, the permitted output orders, resulting from applying the input beam onto the immersion grating 200, comprise zero-order reflection (R₀) and first-order reflection (R₁) outputs. It is desirable to maximize the R₁ output to optimize performance of the grating. In the example use case illustrated in FIG. 2, the input beam is applied to the immersion grating 200 at an incidence angle that is beyond the critical angle for the grating. Furthermore the grating period may be set such that no diffraction into the ambient medium (air) is allowed. As such, all transmitted diffraction orders, zero and non-zero, may be prohibited. In this regard, prohibiting all transmitted orders may be accomplished by: 1) setting the incidence angle of the input beam such that it is greater than critical angle (total internal reflection), which prevents zero order transmission, and 2) setting the grating period small enough so that no diffraction to the outside medium occurs. In other words, due to the refractive index (RI) of the substrate material (glass 220) and/or grating material exceeding RI of the surrounding media, when the incident light is applied at an incidence angle that is beyond the critical angle for the grating and with properly chosen grating period, only reflective orders (e.g., R₀ and R₁) occur. For example, as illustrated the input beam may comprise near-infrared light with wavelengths in the range 1525 nm to 1615 nm, incident at the grating surface with an incidence angle 0=45.53°. In this range of wavelengths, the refractive index (RI) of glass used in the material 220 is approximately 1.8. As such, the R₁ output indicates the case for diffraction at 1615 nm wavelength.

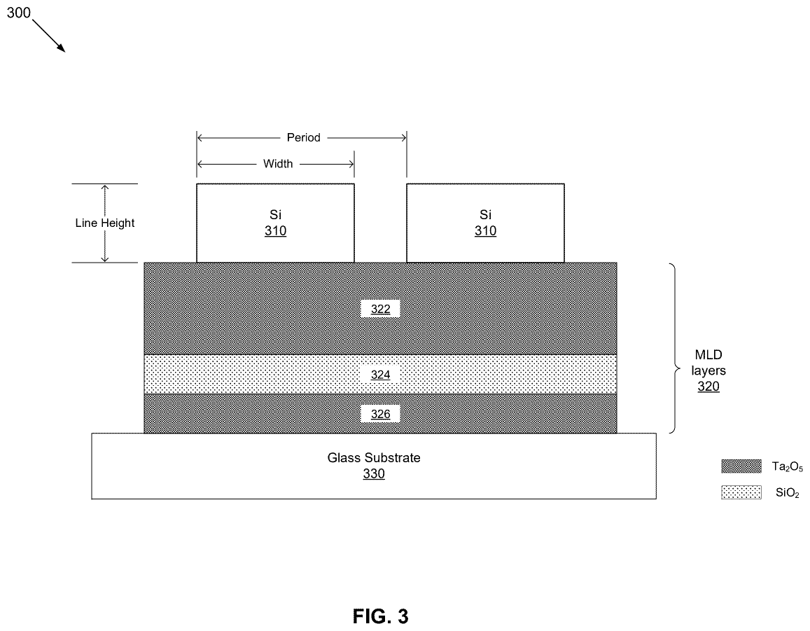

In accordance with the present disclosure, immersion gratings (e.g., the immersion grating 200) may incorporate modified/enhanced morphologies for improving performance thereof. In this regard, such morphologies may incorporate an intermediate layer structure, in-between the grating structure and the substrate layer, with that intermediate layer structure being adaptively configured to enhance performance, particularly with respect to reflective losses of the grating, as described herein. An example embodiment of an immersion grating incorporating one such example morphology is illustrated and described in more detail with respect to FIG. 3.

FIG. 3 illustrates an example immersion grating morphology incorporating a multi-layer dielectric (MLD) structure. Shown in FIG. 3 is immersion grating based morphology 300 (or a portion thereof). In particular, illustrated in FIG. 3 is a cross-section of the morphology 300 showing the grating layer and the underlying layers associated therewith.

As shown in FIG. 3, the morphology 300 comprises single-layer grating lines 310, a multi-layer structure 320, and a substrate (e.g., glass based) 330. In the portion of the morphology 300 illustrated in FIG. 3, only two (2) grating lines are shown, but it should be understood that the morphology 300 consists of a large number of lines. Each of the grating lines 310 comprises a single layer composed of the same material. For example, in the example embodiment illustrated in FIG. 3, the grating lines 310 may comprise silicon based single-layer grating lines. Further, while the grating lines are shown as having a cross-section profile with a simple rectangular shape, the disclosure is not limited to such shape, and as such other shapes may be used (if deemed suitable)—e.g., the cross-section profile of the lines may be trapezoidal or have curvilinear contours and modelled and optimized accordingly.

The grating lines 310 may be characterized by, in addition to the material used therein, one or more grating related parameters, such as line height, line width, grating period, and duty cycles (DC). These parameters are illustrated in FIG. 3, with respect to the grating lines 310 of the morphology 300. In this regard, as used herein, the duty cycle is defined as line width (that is, width of each of the grating lines 310) divided by the grating period—that is, duty cycle=line width/grating period. As such, the line width of the grating lines 310 may simply be indicated in terms of the duty cycle where the grating period is indicated. The values of the grating related parameters may be set to optimize performance. For example, in the morphology 300, the line height may be 340 nm, and the grating period may be 580 nm. Further, the grating lines 310 have a duty cycle of 67%+2%, and as such with a grating period of 580 nm, the line width of the grating lines 310 in the morphology 300 may be 388.6 nm±11.6 nm. In instances where the cross-section of the lines is not rectangular (e.g., trapezoidal or with curvilinear sidewalls), line width and duty cycle may be determined using defined parameters, at a specific height or as average value at different heights—that is, averaged over multiple heights.

The multi-layer structure 320 comprises a set of layers adaptively configured (e.g., based on selection of material used therein, dimensions thereof, arrangement of the layers, etc.) for providing reflectivity performance meeting predetermined criteria. In this regard, multi-layer structure 320 may be configured to minimize reflections, and for optimized performance when functioning as such. In various example implementations, the multi-layer structure 320 may comprise a plurality of dielectric layers. As such, the multi-layer structure 320 (and similar structures) are referred to herein as multi-layer dielectric (MLD) based structure, MLD coating, or simply as MLD.

For example, in the morphology 300, the multi-layer structure 320 comprises thee (3) layers: a first dielectric layer 322, a second dielectric layer 324, and a third dielectric layer 326. In some implementations, the different layers in the multi-layer structure 320 may comprise material having different refractive index (RI). The different layers in the multi-layer structure 320 may comprise, for example, alternating layers of different refractive index (RI) material. In this regard, in some implementations, the multi-layer structure 320 may comprise alternating layers of high refractive index (RI) and low refractive index (RI) material. For example, in the morphology 300, the first dielectric layer 322 may comprise high-RI material, and beyond the first dielectric layer 322, the multi-layer structure 320 may comprise pairs of L-H based layers. Preferably, the same material is used throughout. As such, in the example embodiment illustrated in FIG. 3, the multi-layer structure 320 in the morphology 300 comprises am H-L-H arrangement. Nonetheless, in some instances, different high-RI and/or low-RI material (and layers comprising such material) may be used. The material used in the multi-layer structure 320 may be selected for optimized performance.

The substrate 330 may comprise suitable material and may have preset dimensions, for optimizing performance. For example, as shown in the example embodiment illustrated in FIG. 3, the substrate 330 may comprise a glass (e.g., SiO₂) based substrate.

Various parameters or characteristics of at least some of the components and/or features of the morphology 300 may be adaptively selected or adjusted based on the desired performance. In this regard, this may comprise determining absolute values, relative values (e.g., a value of a parameter associated with one component or feature as ratio of a value of a parameter associated with another component or feature), and the like. For example, a thickness of particular structure or layer may be determined, either as an actual value, or as relative value (e.g., percentage of) of another structure or layer in the morphology. In some embodiments, an optimization algorithm (e.g., least squares minimization of a merit function, related to, for example, rigorous coupled-wave analysis (RCWA) of diffraction efficiency) may be used in determining at least some of these parameters or characteristics.

For example, such optimization algorithm may be used in determining the thickness of the multi-layer structure 320 as a whole, determining the number of layers and/or thickness of each layer in the multi-layer structure 320, and/or selection of material used in each of the layers therein. For example, as illustrated in FIG. 3, in the morphology 300, based on use of such optimization algorithm, the three individual layers (starting with first dielectric layer 322) in the multi-layer structure 320 may have thickness of, respectively: 370 nm, 120 nm, and 120 nm, with the first dielectric layer 322 and the third dielectric layer 326 comprising tantalum pentoxide (Ta₂O₅), and the second dielectric layer 324 comprising silicon dioxide (SiO₂). The optimization algorithm may also be used in determining the material selected for use in the grating lines 310 and/or the grating related parameters noted above. Nonetheless, it should be understood that the disclosure is not limited to such arrangement and/or material.

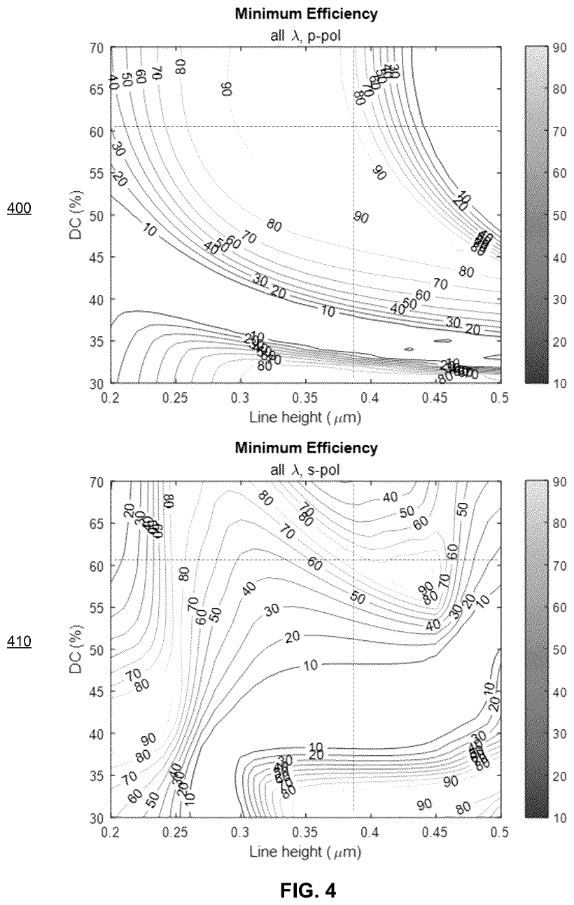

Use of morphologies implemented based in accordance with the present disclosure (such as morphology 300) in immersion gratings yield improved performance. Such performance improvement is illustrated in FIGS. 4-9. In this regard, performance contours are plotted for minimum diffraction efficiency across a wavelength range of 1525 nm to 1615 nm with an incidence angle of 45.5°, and with the crosshair in each plot identifying the grating morphology (defined by duty cycle (DC) and line height) with the largest value for this minimum diffraction efficiency.

FIG. 4 illustrates performance maps for an example immersion grating implemented without MLD. Shown in FIG. 4 are contour plots 400 and 410, comprising data representing performance for an immersion grating implemented without MLD.

In this regard, each of plots 400 and 410 comprises data representing performance (minimum diffraction efficiency in %, for all wavelengths (A)), for two polarizations-namely, p-polarization and s-polarization-components of an immersion grating without MLD (e.g., having morphology similar to the morphology 300 of FIG. 3, but without the MLD structure thereof—that is, without the multi-layer structure 320), as a function of duty cycle (DC) (y-axis) and line height in μm (x-axis) of the grating lines.

As shown in FIG. 4, each of plots 400 and 410 comprises contours of minimum diffraction efficiency—that is, contour lines connecting data points corresponding to particular minimum diffraction efficiency value. For example, as used herein, minimum diffraction efficiency corresponds to the minimum value for R₁ over swept wavelengths (A), and for the two polarization components. In this regard, as illustrated in FIG. 4, performance contours for minimum diffraction efficiency are plotted across a specified wavelength range (e.g., 1525 nm to 1615 nm) with an incidence angle of 45.5°. Each of the crosshairs illustrated in the plots indicates the grating morphology is selected to provide the highest possible minimum efficiency (the largest value for the minimum diffraction efficiency for the grating morphology as defined by duty cycle and line height with).

The plots 400 and 410 (or, particularly, counters therein) may be interpreted similarly to a topographical map. As such, each of the plots 400 and 410 indicates the range of variation in the two parameters that can be tolerated in order to realize a particular performance level. For example, in order to realize a 75% minimum diffraction efficiency, these two parameters must be constrained to the interior of the “75” contour. In other words, the 75 contour encloses all the data points corresponding to minimum diffraction efficiency of 75% or more, the 80 contour encloses all the data points corresponding to minimum diffraction efficiency of 80% or more, and so forth.

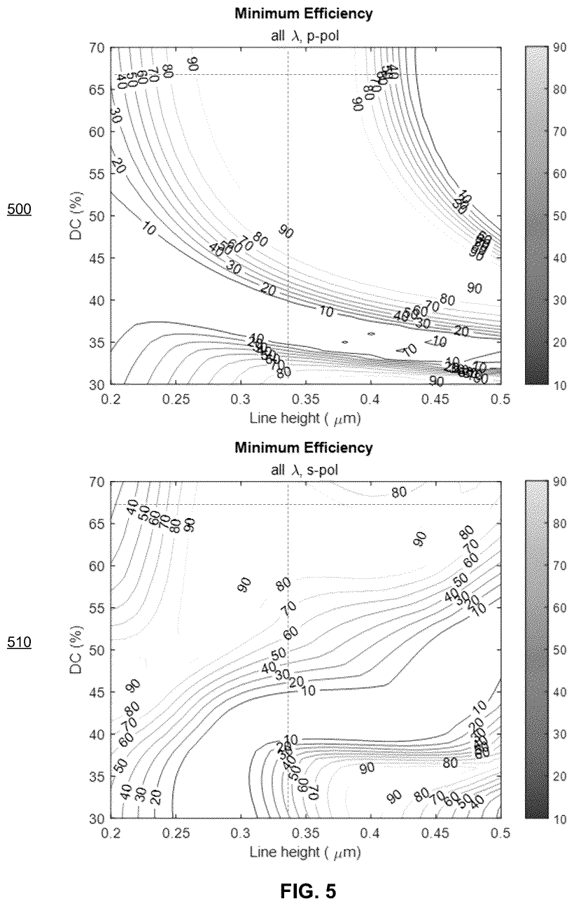

FIG. 5 illustrates performance maps for an example immersion grating implemented with MLD. Shown in FIG. 5 are contour plots 500 and 510, comprising data representing performance for an immersion grating implemented with MLD.

In this regard, each of plots 500 and 510 comprises data representing performance (minimum diffraction efficiency in %, for all wavelengths (A)), for two polarization-namely, p-polarization and s-polarization-components of an immersion grating with MLD (e.g., having morphology similar to the morphology 300 of FIG. 3), as a function of duty cycle (DC) (y-axis) and line height in μm (x-axis) of the grating lines. The crosshair indicates the grating morphology is selected to provide the highest possible minimum efficiency.

As illustrated by the plots in FIGS. 4 and 5, particularly by comparing the corresponding polarization plots (e.g., plot 400 compared to plot 500 for p-polarization, and plot 410 compared to plot 510 for s-polarization), the inclusion of MLD structure, particularly as described herein (e.g., the multi-layer structure 320 in the morphology 300), yields clear improvement. In this regard, as illustrated in plots 400, 410, 500, and 510, regions corresponding to particular minimum diffraction efficiency values (e.g., 90%) are larger when using an MLD structure for both polarization components. The use of an MLD structure also ensures better alignment with the largest value for this minimum diffraction efficiency. For example, as illustrated by the plots of FIGS. 4 and 5, the inclusion of the MLD structure may offer benefit in two ways: 1) increased peak efficiencies for both polarizations, and 2) a shift in the peak location for s-polarization, leads to improved overlap between good performing regions for p-polarization and s-polarization.

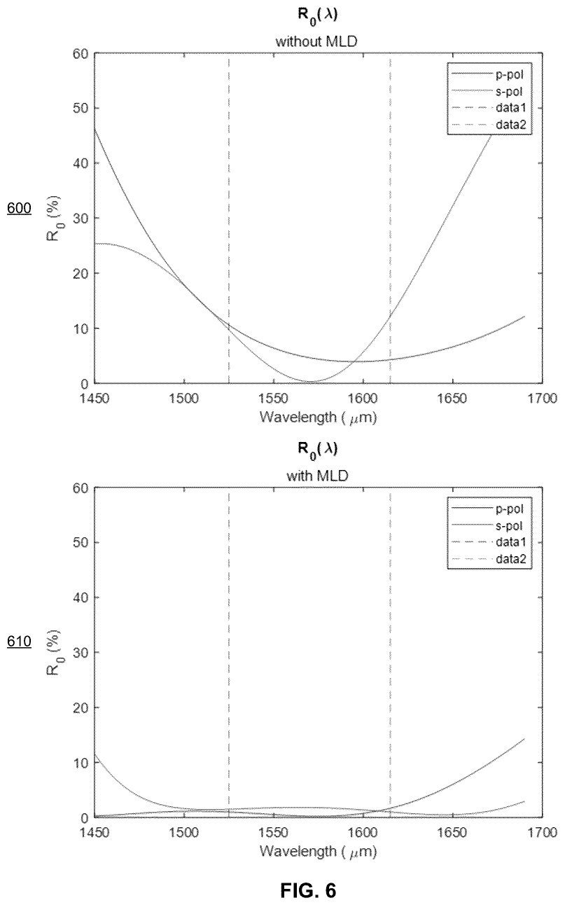

The improvement(s) that the inclusion of an MLD structure may yield is further illustrated in FIGS. 6-9, in which the diffraction efficiencies, as a function of wavelength or incidence angle, for immersion gratings with MLD and without MLD are compared.

FIG. 6 is a plot illustrating zero-order reflection (R₀) as a function of wavelength for example immersion gratings. Shown in FIG. 6 are plots 600 and 610, comprising data representing zero-order reflection (R₀) as function of wavelengths (A), for, respectively, an immersion grating implemented without MLD (e.g., having morphology similar to the morphology 300 of FIG. 3, but without the MLD structure thereof—that is, the multi-layer structure 320) and an immersion grating with MLD (e.g., having morphology similar to the morphology 300 of FIG. 3). In particular, each of plots 600 and 610 comprises data representing zero-order reflection (R₀), for two polarization components (p-polarization and s-polarization), as function(s) of wavelengths (A).

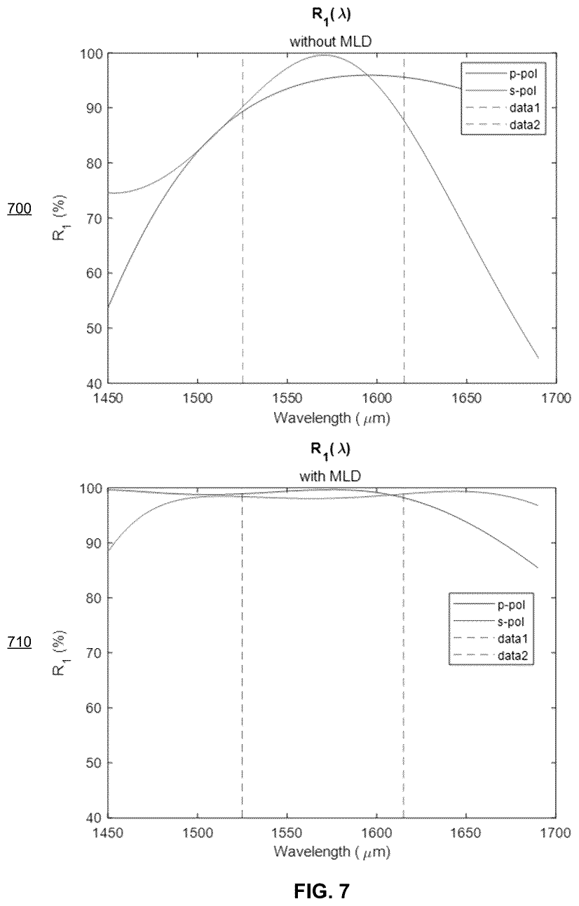

FIG. 7 is a plot illustrating first-order reflection (R₁) as a function of wavelength for example immersion gratings. Shown in FIG. 7 are plots 700 and 710, comprising data representing first-order reflection (R₁) as function of wavelengths (A), for, respectively, an immersion grating implemented without MLD (e.g., having morphology similar to the morphology 300 of FIG. 3, but without the MLD structure thereof—that is, the multi-layer structure 320) an immersion grating with MLD (e.g., having morphology similar to the morphology 300 of FIG. 3). In particular, each of plots 700 and 710 comprises data representing first-order reflection (R₁), for two polarization components (p-polarization and s-polarization), as function(s) of wavelengths (A).

As illustrated by plots 600, 610, 710, and 720, the inclusion of MLD structure, provides a reduction in R₀ across a broad wavelength range that exactly complements the improvement in R₁ (due to there being only two possible output orders).

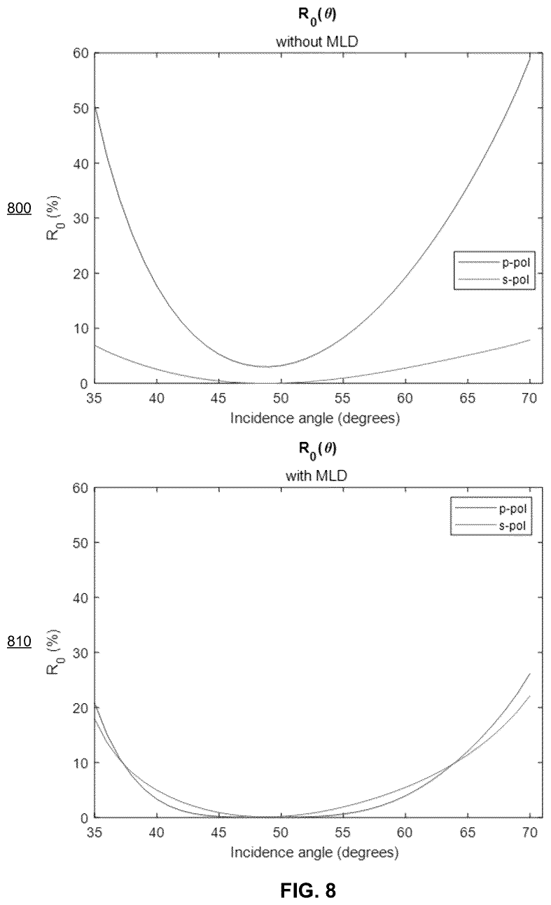

FIG. 8 is a plot illustrating zero-order reflection (R₀) as a function of incidence angle for example immersion gratings. Shown in FIG. 8 are plots 800 and 810, comprising data representing zero-order reflection (R₀) as function of incidence angle (θ), for, respectively, an immersion grating implemented without MLD (e.g., having morphology similar to the morphology 300 of FIG. 3, but without the MLD structure thereof—that is, the multi-layer structure 320) and an immersion grating with MLD (e.g., having morphology similar to the morphology 300 of FIG. 3). In particular, each of plots 800 and 810 comprises data representing zero-order reflection (R₀), for two polarization components (p-polarization and s-polarization), as function(s) of incidence angle (θ).

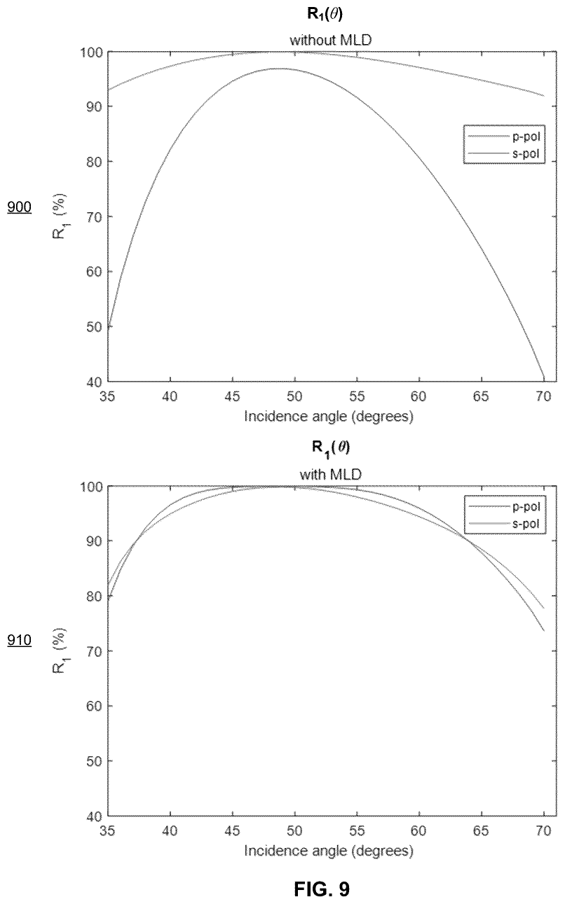

FIG. 9 is a plot illustrating first-order reflection (R₁) as a function of incidence angle for example immersion gratings. Shown in FIG. 9 are plots 900 and 910, comprising data representing first-order reflection (R₁) as function of incidence angle (θ), for, respectively, an immersion grating implemented without MLD (e.g., having morphology similar to the morphology 300 of FIG. 3, but without the MLD structure thereof—that is, the multi-layer structure 320) and an immersion grating with MLD (e.g., having morphology similar to the morphology 300 of FIG. 3). In particular, each of plots 900 and 910 comprises data representing first-order reflection (R₁), for two polarization components (p-polarization and s-polarization), as function(s) of incidence angle (θ).

For example, in FIG. 8 and FIG. 9, performance may be plotted, as function(s) of incidence angle, for a particular central wavelength (e.g., λ=1570 nm). In this regard, the angular range may be chosen to cover the range where the number of permitted orders is constant (e.g., below 33.74° T₀ is permitted, while above 71.5° T₁ is permitted). As illustrated by plots 800, 810, 910, and 920, the inclusion of an MLD structure provides improved performance—e.g., allowing for improved peak diffraction efficiency for p-polarization, weaker angular dependence for p-polarization, and similar performance for both polarizations across the angular range explored

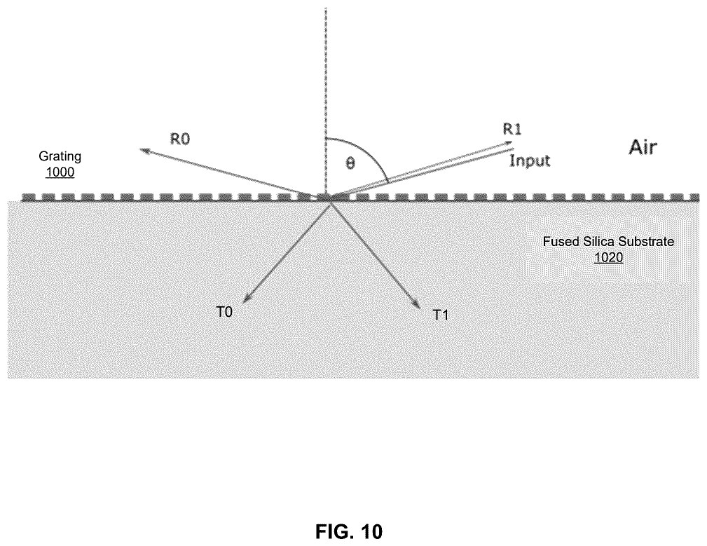

FIG. 10 illustrates an example transmission grating and use case scenario associated therewith. Shown in FIG. 10 is transmission grating 1000 and use case scenario associated therewith, such as during grating operation using the transmission grating 1000.

As illustrated, the transmission grating 1000 comprises a grating structure, which comprises a repetitive structure having a surface with close, equidistant, and parallel lines, separated by corresponding close, equidistant, and parallel spaces, configured for resolving incident lights. The grating structure is disposed on top of material 1020 (e.g., fused silica). Also illustrated in FIG. 10 is an example grating operation, using the transmission grating 1000, with single propagating order. In this regard, an input beam (incident light) is applied onto the transmission grating 1000, with the input beam striking the transmission grating 1000 from the top side—that is, it is applied on the grating structure in air or a vacuum on top of the grating structure-resulting in a number of corresponding outputs.

For example, as illustrated the input beam may comprise near-infrared light with wavelengths in the range 1525 nm to 1615 nm (e.g., λ=1548 nm), incident at the grating surface with an incidence angle 0=74.7°, with the transmission grating having line density of 1229 lines/mm. In this range of wavelengths, the refractive index (RI) of the fused silica used in the material 1020 is approximately 1.45. As shown in FIG. 10, under these conditions, the permitted output orders, resulting from applying the input beam onto the transmission grating 1000, comprise zero-order reflection (R₀), first-order reflection (R₁), zero-order transmittance (T₀), and first-order transmitted diffraction efficiency (T₁) outputs.

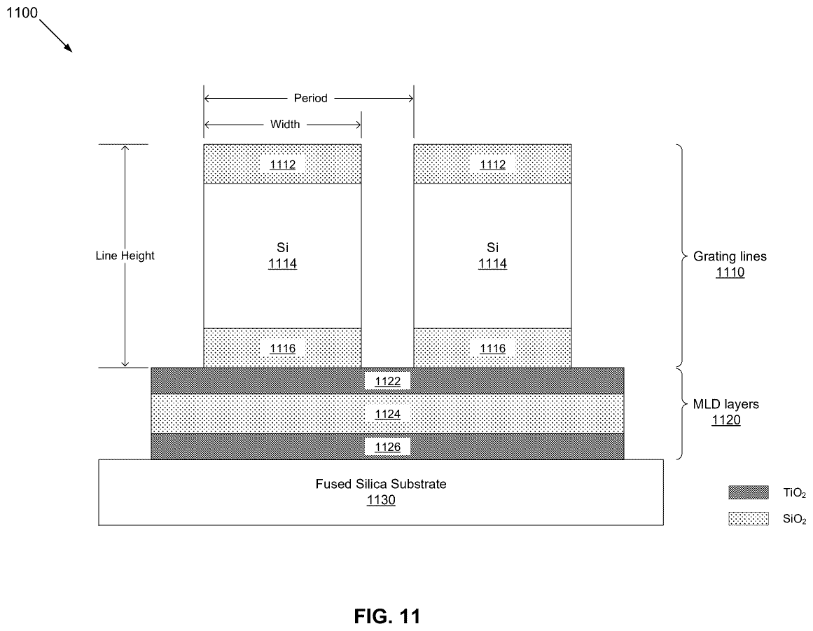

In accordance with the present disclosure, transmission gratings (e.g., the transmission grating 1000) may incorporate modified/enhanced morphologies for improving performance thereof. In this regard, as noted such morphology may incorporate an intermediate layer structure, which may be adaptively configured to enhance performance, particularly with respect to reflective losses of the transmission gratings. An example embodiment of a transmission grating incorporating one such example morphology is illustrated and described in more detail with respect to FIG. 11.

FIG. 11 illustrates an example transmission grating morphology incorporating a multi-layer dielectric (MLD) structure. Shown in FIG. 11 is transmission grating based morphology 1100 (or a portion thereof). In particular, illustrated in FIG. 11 is a cross-section of the morphology 1100 showing the grating layer and the underlying layers associated therewith.

As shown in FIG. 11, the morphology 1100 comprises multi-layer grating lines 1110, a multi-layer structure 1120, and a substrate (e.g., fused silica based) 1130. In this regard, in the portion of the morphology 1100 illustrated in FIG. 11, only two (2) grating lines 1110 are shown, but it should be understood that the morphology 1100 consists of a large number of lines.

Each of the grating lines 1110 comprises multiple layers. For example, in the morphology 1100 illustrated in FIG. 11, the grating lines 1110 may comprise three (3) layers: a first grating layer 1112, a second grating layer 1114, and a third grating layer 1116. The grating layers may comprise different material. For example, the layers used in the grating lines 1110 may comprise material having different refractive index (RI). The grating lines 1110 may comprise, for example, alternating layers of different refractive index (RI) material. In this regard, in some implementations, arrangements comprising low-RI material and high-RI material may be used. The low-RI material based layers and high-RI material based layers may be alternated. Nonetheless, the disclosure is not limited to such multi-layer arrangement(s), and any other suitable arrangement may be used.

The grating lines 1110 may be characterized by, in addition to the material used therein, one or more grating related parameters, such as line height, line width, grating period, and duty cycles (DC). These parameters are illustrated in FIG. 11, with respect to the grating lines 1110 of the morphology 1100. In this regard, as used herein, the duty cycle is defined as line width (that is, width of each of the grating lines 1110) divided by the grating period—that is, duty cycle=line width/grating period. As such, the line width of the grating lines 1110 may simply be indicated in terms of the duty cycle where the grating period is indicated. The values of the grating related parameters may be set to optimize performance. For example, in the morphology 1100, the line height may be 863 nm, and the grating period may be 813.7 nm. Further, the grating lines 1110 have a duty cycle of 45%+2%, and as such with a grating period of 580 nm, the line width of the grating lines 1110 in the morphology 1100 may be 366.16 nm+16.27 nm. Further, while the grating lines are shown as having a cross-section profile with a simple rectangular shape, the disclosure is not limited to such shape, and as such other shapes may be used (if deemed suitable)—e.g., the cross-section profile of the lines may be trapezoidal or have curvilinear contours and/or sidewalls, and modelled and optimized accordingly. In this regard, in such cases, linewidth and duty cycle may be defined as a specific height or as an average over multiple heights.

The multi-layer structure 1120 comprises a set of layers adaptively configured (e.g., based on selection of material used therein, dimensions thereof, arrangement of the layers, etc.) for providing reflectivity performance meeting predetermined criteria. In this regard, multi-layer structure 1120 may be configured for functioning to reduce reflection, and for optimized performance when functioning as such. In various example implementations, the multi-layer structure 1120 may comprise a plurality of dielectric layers. As such, the multi-layer structure 1120 (and similar structures) are referred to herein as multi-layer dielectric (MLD) based structure, MLD coating, or simply as MLD.

For example, in the morphology 1100, the multi-layer structure 1120 comprises thee (3) layers: a first dielectric layer 1122, a second dielectric layer 1124, and a third dielectric layer 1126. In some implementations, the different layers in the multi-layer structure 1120 may comprise material having different refractive index (RI). The different layers in the multi-layer structure 1120 may comprise, for example, alternating layers of different refractive index (RI) material. In this regard, in some implementations, the multi-layer structure 1120 may comprise alternating layers of high refractive index (RI) and low refractive index (RI) material. For example, in the morphology 1100, the first dielectric layer 1122 may comprise high-RI material, and beyond the first dielectric layer 1122, the multi-layer structure 1120 may comprises pairs of L-H based layers. Preferably, the same material is used throughout. As such, in the example embodiment illustrated in FIG. 11, the multi-layer structure 1120 in the morphology 1100 comprises am H-L-H arrangement. Nonetheless, in some instances, different high-RI and/or low-RI material (and layers comprising such material) may be used. The material used in the multi-layer structure 1120 may be selected for optimized performance.

The substrate 1130 may comprise suitable material and may have preset dimensions, for optimizing performance. For example, as shown in the example embodiment illustrated in FIG. 11, the substrate 1130 may comprise a fused silica based substrate.

Various parameters or characteristics of at least some of the components and/or features of the morphology 1100 may be adaptively selected or adjusted based on the desired performance. In this regard, this may comprise determining absolute values, relative values (e.g., a value of a parameter associated with one component or feature as ratio of a value of a parameter associated with another component or feature), and the like. For example, a thickness of a particular structure or layer may be determined, either as an actual value, or as a relative value (e.g., percentage of) of another structure or layer in the morphology. In some embodiments, an optimization algorithm (e.g., least squares minimization of a merit function, related to, for example, rigorous coupled-wave analysis (RCWA) of diffraction efficiency) may be used in determining at least some of these parameters or characteristics.

For example, such optimization algorithm may be used in determining the thickness of the multi-layer structure 1120 as a whole, determining the number of layers and/or thickness of each layer in the multi-layer structure 1120, and/or selection of material used in each of the layers therein. For example, as illustrated in FIG. 11, in the morphology 1100, based on use of such optimization algorithm, the 11 individual layers (starting with first dielectric layer 1122) in the multi-layer structure 1120 may have thickness of, respectively: 202 nm, 162 nm, and 45 nm, with the first dielectric layer 1122 and the third dielectric layer 1126 comprising titanium dioxide (TiO₂), and the second dielectric layer 1124 comprising silicon dioxide (SiO₂). Nonetheless, it should be understood that the disclosure is not limited to such arrangement and/or material.

Similarly, such optimization algorithm may be used in determining the thickness of each of the grating lines 1110 as a whole, determining the number of layers and/or thickness of each layer in each of the grating lines 1110, and/or selection of material used in each of the layers therein. For example, as illustrated in FIG. 11, in the morphology 1100, based on use of such optimization algorithm, in the grating lines 1110, which has an overall line height may of 863 nm, the three individual layers (starting with first grating layer 1112) of may have thickness of, respectively: 356 nm, 450 nm, and 57 nm, with the first grating layer 1112 and the third grating layer 1116 comprising silicon dioxide (SiO₂), and the second grating layer 1114 comprising silicon (Si). The optimization algorithm may also be used in determining the material selected for use in the grating lines 1110 and/or the grating related parameters noted above. Nonetheless, it should be understood that the disclosure is not limited to such arrangement and/or material.

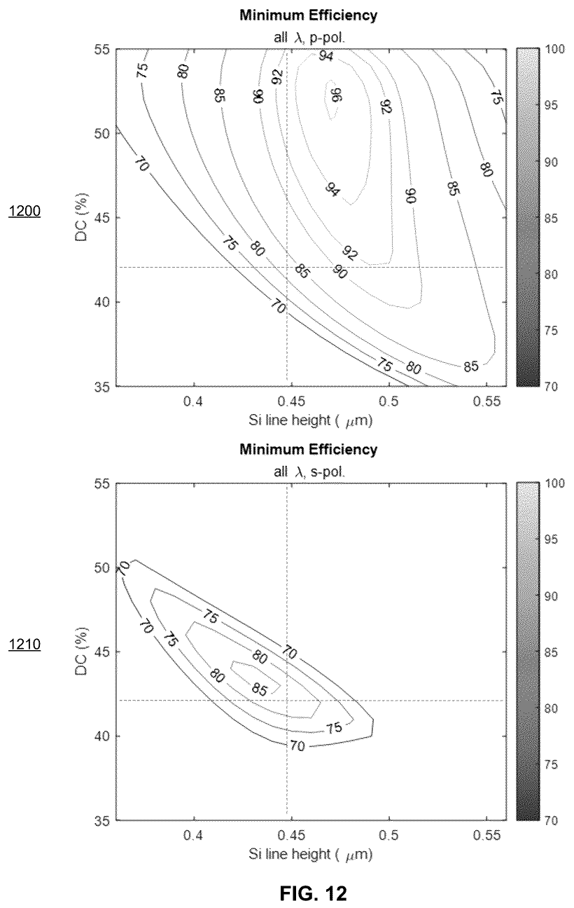

Use of morphologies implemented based in accordance with the present disclosure (such as morphology 1100) in transmission gratings yield improved performance. In this regard, the morphology 1100 may facilitate improved performance for particular wavelength ranges. For example, a transmission grating incorporating the morphology 1100 as illustrated and described with respect to FIG. 11 may be configured particularly for improved performance over a wavelength range of 1528 nm to 1569 nm. Such performance improvement is illustrated in FIGS. 12-25, which show performance improvement when using a transmission grating incorporating the morphology 1100 as described herein. In this regard, as the grating lines 1110 in the morphology 1100 comprise multiple layers, results are shown for tuning the center layer (the amorphous silicon) while keeping the top and bottom (SiO2) layer thicknesses fixed. Performance contours are plotted for minimum diffraction efficiency across a wavelength range of 1528 nm to 1569 nm, with an incidence angle of 74.7°, and with the crosshair in each plot identifying the grating morphology (defined by duty cycle (DC) and line height) with the largest value for this minimum diffraction efficiency.

FIG. 12 illustrates performance maps for an example transmission grating implemented without MLD. Shown in FIG. 12 are contour plots 1200 and 1210, comprising data representing performance for a transmission grating implemented without MLD.

In this regard, each of plots 1200 and 1210 comprises data representing performance (minimum diffraction efficiency in %, for all wavelengths (A)), for two polarizations—namely, p-polarization and s-polarization—components of a transmission grating without MLD (e.g., having morphology similar to the morphology 1100 of FIG. 11, but without the MLD structure thereof—that is, the multi-layer structure 1120), as a function of duty cycle (DC) (y-axis) and line height in μm (x-axis) of the grating lines.

As shown in FIG. 12, each of plots 1200 and 1210 comprises contours of minimum diffraction efficiency—that is, contour lines connecting data points corresponding to particular minimum diffraction efficiency value. For example, as used herein, minimum diffraction efficiency over swept wavelengths (A), and for the two polarization components. The crosshair indicates the grating morphology selected to provide the highest possible minimum efficiency.

The plots 1200 and 1210 (or, particularly, counters therein) may be interpreted similarly to a topographical map. As such, each of the plots 1200 and 1210 indicates the range of variation in the two parameters that can be tolerated in order to realize a particular performance level. For example, in order to realize a 75% minimum diffraction efficiency, these two parameters must be constrained to the interior of the “75” contour. In other words, the 75 contour encloses all the data points corresponding to minimum diffraction efficiency of 75% or more, the 80 contour encloses all the data points corresponding to minimum diffraction efficiency of 80% or more, and so forth.

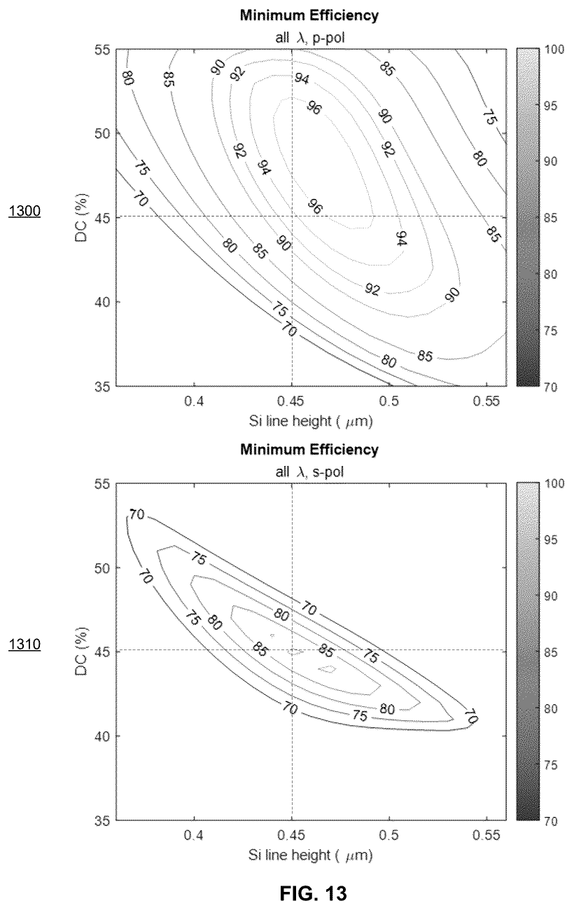

FIG. 13 illustrates performance maps for an example transmission grating implemented with MLD. Shown in FIG. 13 are contour plots 1300 and 1310, comprising data representing performance for a transmission grating implemented with MLD.

In this regard, each of plots 1300 and 1310 comprises data representing performance (minimum diffraction efficiency in %, for all wavelengths (A)), for two polarizations—namely, p-polarization and s-polarization components—of a transmission grating with MLD (e.g., having morphology similar to the morphology 1100 of FIG. 11), as a function of duty cycle (DC) (y-axis) and line height in μm (x-axis) of the grating lines. The crosshair indicates the grating morphology selected to provide the highest possible minimum efficiency.

As illustrated by the plots in FIGS. 12 and 13, particularly by comparing the corresponding polarization plots (e.g., plot 1200 compared to plot 1300 for p-polarization, and plot 1210 compared to plot 1310 for s-polarization), the inclusion of MLD structure, particularly as described herein (e.g., the multi-layer structure 1120 in the morphology 1100), yields clear improvement. In this regard, as illustrated in plots 1200, 1210, 1300, and 1310, regions corresponding to particular minimum diffraction efficiency values (e.g., 90%) are larger when using an MLD structure for both polarization components. The use of an MLD structure also ensures better alignment with the largest value for this minimum diffraction efficiency. For example, as illustrated by the plots of FIGS. 12 and 13, the inclusion of the MLD structure may offer benefit in two ways: 1) overall increase in performance levels for both polarizations, and 2) better alignment of high-performance regions for p-polarization and s-polarization.

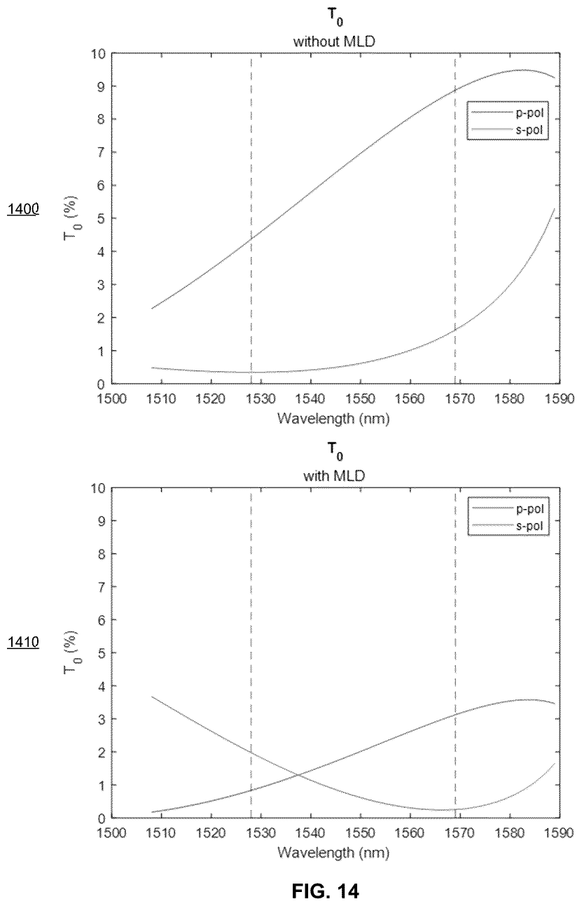

The improvement(s) that the inclusion of an MLD structure may yield are further illustrated in FIGS. 14-25, in which the diffraction efficiencies, as a function of wavelength or incidence angle, for transmission gratings with MLD and without MLD are compared.

FIG. 14 is a plot illustrating zero-order transmittance (T₀) as a function of wavelength for example transmission gratings. Shown in FIG. 14 are plots 1400 and 1410, comprising data representing zero-order transmittance (T₀) as function of wavelengths (λ), for, respectively, a transmission grating implemented without MLD (e.g., having morphology similar to the morphology 1100 of FIG. 11, but without the MLD structure thereof—that is, the multi-layer structure 1120) and a transmission grating with MLD (e.g., having morphology similar to the morphology 1100 of FIG. 11). In particular, each of plots 1400 and 1410 comprises data representing zero-order transmittance (T₀), for two polarization components (p-polarization and s-polarization), as function(s) of wavelengths (λ).

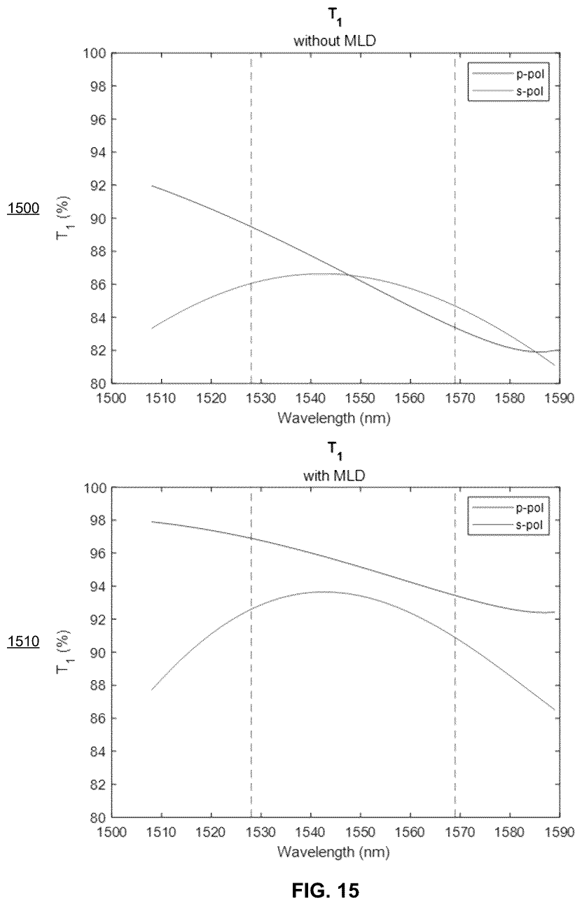

FIG. 15 is a plot illustrating first-order transmitted diffraction efficiency (T₁) as a function of wavelength for example transmission gratings. Shown in FIG. 15 are plots 1500 and 1510, comprising data representing first-order transmitted diffraction efficiency (T₁) as function of wavelengths (λ), for, respectively, a transmission grating implemented without MLD (e.g., having morphology similar to the morphology 1100 of FIG. 11, but without the MLD structure thereof—that is, the multi-layer structure 1120) and a transmission grating with MLD (e.g., having morphology similar to the morphology 1100 of FIG. 11). In particular, each of plots 1500 and 1510 comprises data representing first-order transmitted diffraction efficiency (T₁), for two polarization components (p-polarization and s-polarization), as function(s) of wavelengths (λ).

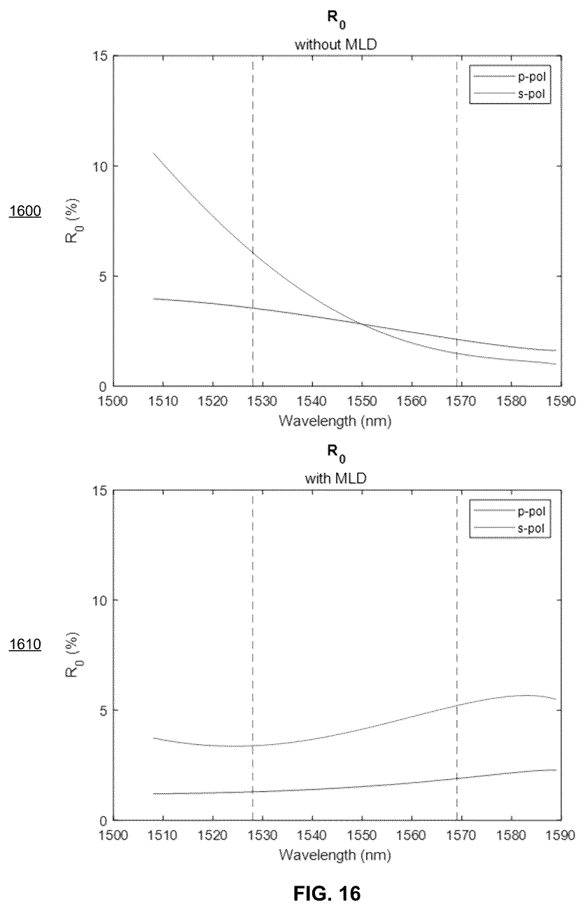

FIG. 16 is a plot illustrating zero-order reflection (R₀) as a function of wavelength for example transmission gratings. Shown in FIG. 16 are plots 1600 and 1610, comprising data representing zero-order reflection (R₀) as function of wavelengths (A), for, respectively, a transmission grating implemented without MLD (e.g., having morphology similar to the morphology 1100 of FIG. 11, but without the MLD structure thereof—that is, the multi-layer structure 1120) and a transmission grating with MLD (e.g., having morphology similar to the morphology 1100 of FIG. 11). In particular, each of plots 1600 and 1610 comprises data representing zero-order reflection (R₀), for two polarization components (p-polarization and s-polarization), as function(s) of wavelengths (A).

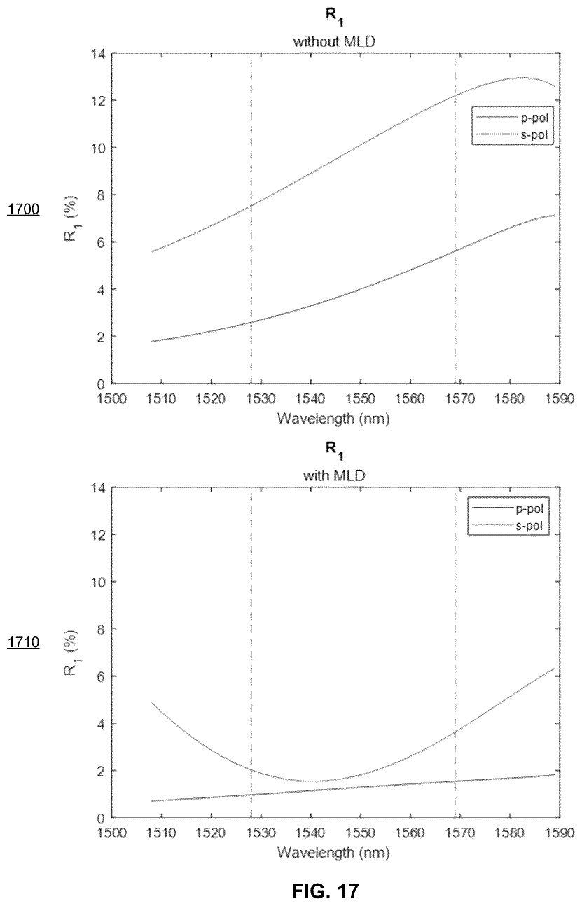

FIG. 17 is a plot illustrating first-order reflection (R₁) as a function of wavelength for example transmission gratings. Shown in FIG. 17 are plots 1700 and 1710, comprising data representing first-order reflection (R₁) as function of wavelengths (A), for, respectively, a transmission grating implemented without MLD (e.g., having morphology similar to the morphology 1100 of FIG. 11, but without the MLD structure thereof—that is, the multi-layer structure 1120) and a transmission grating with MLD (e.g., having morphology similar to the morphology 1100 of FIG. 11). In particular, each of plots 1700 and 1710 comprises data representing first-order reflection (R₁), for two polarization components (p-polarization and s-polarization), as function(s) of wavelengths (A).

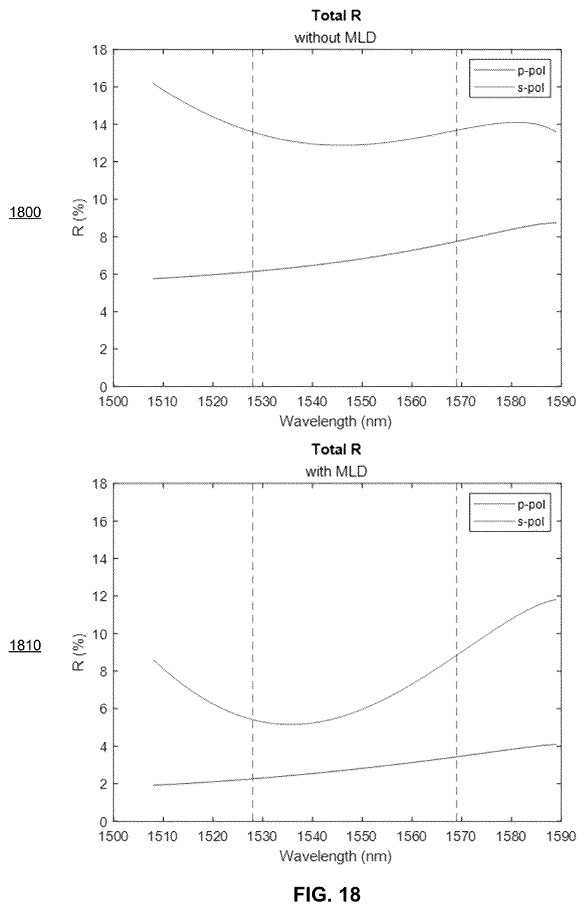

FIG. 18 is a plot illustrating total reflection (R) as a function of wavelength for example transmission gratings. Shown in FIG. 18 are plots 1800 and 1810, comprising data representing total reflection (R) as function of wavelengths (A), for, respectively, a transmission grating implemented without MLD (e.g., having morphology similar to the morphology 1100 of FIG. 11, but without the MLD structure thereof—that is, the multi-layer structure 1120) and a transmission grating with MLD (e.g., having morphology similar to the morphology 1100 of FIG. 11). In particular, each of plots 1800 and 1810 comprises data representing total reflection (R), for two polarization components (p-polarization and s-polarization), as function(s) of wavelengths (A).

As illustrated by the plots in FIGS. 14-18, the inclusion of an MLD structure yields improvement in transmission gratings. In this regard, under the described illumination conditions, transmission grating produces four output orders: R₀, R₁, T₀, T₁. Comparing the plots for each output order illustrates that the grating with an MLD structure therein exhibits smaller total reflectivity across the entire wavelength range and for both polarizations (p-polarization and s-polarization). Further, the grating with an MLD structure exhibits increased T₁ across the entire wavelength range and for both polarizations (p-polarization and s-polarization).

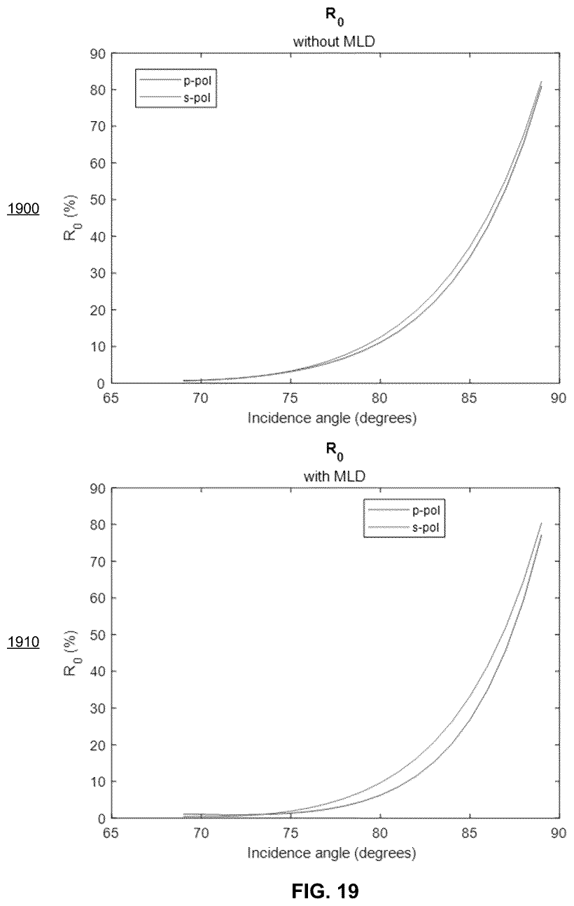

FIG. 19 is a plot illustrating zero-order reflection (R₀) as a function of incidence angle for example transmission gratings. Shown in FIG. 19 are plots 1900 and 1910, comprising data representing zero-order reflection (R₀) as a function of incidence angle (θ), for, respectively, a transmission grating implemented without MLD (e.g., having morphology similar to the morphology 1100 of FIG. 11, but without the MLD structure thereof—that is, the multi-layer structure 1120) and a transmission grating with MLD (e.g., having morphology similar to the morphology 1100 of FIG. 11). In particular, each of plots 1900 and 1910 comprises data representing zero-order reflection (R₀), for two polarization components (p-polarization and s-polarization), as function(s) of incidence angle (θ).

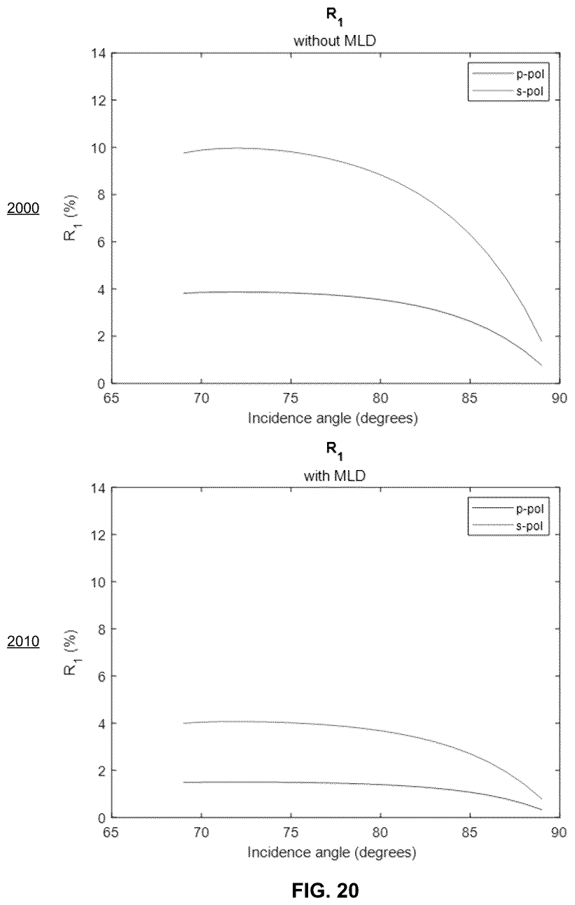

FIG. 20 is a plot illustrating first-order reflection (R₁) as a function of incidence angle for example transmission gratings. Shown in FIG. 20 are plots 2000 and 2010, comprising data representing first-order reflection (R₁) as function of incidence angle (θ), for, respectively, a transmission grating implemented without MLD (e.g., having morphology similar to the morphology 1100 of FIG. 11, but without the MLD structure thereof—that is, the multi-layer structure 1120) and a transmission grating with MLD (e.g., having morphology similar to the morphology 1100 of FIG. 11). In particular, each of plots 2000 and 2010 comprises data representing first-order reflection (R₁), for two polarization components (p-polarization and s-polarization), as function(s) of incidence angle (θ).

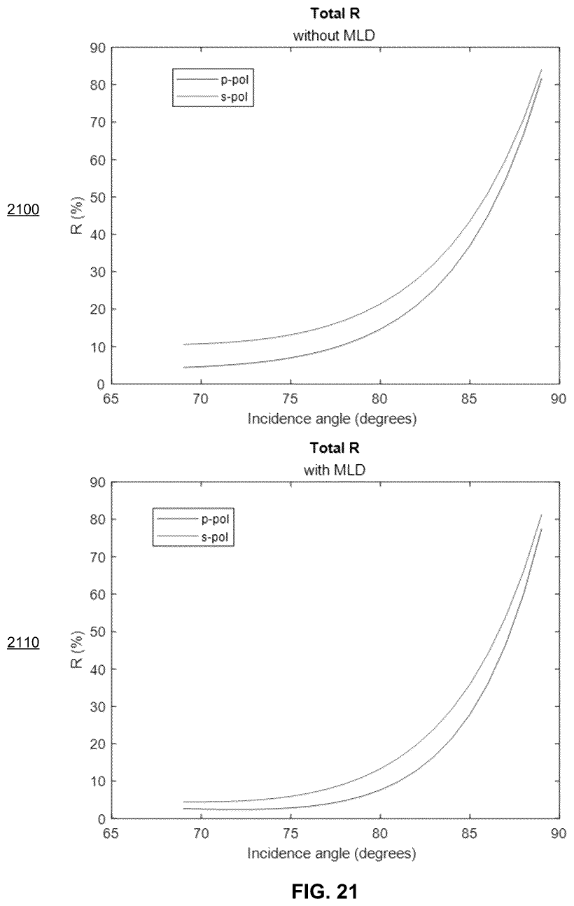

FIG. 21 is a plot illustrating total reflection (R) as a function of incidence angle for example transmission gratings. Shown in FIG. 21 are plots 2100 and 2110, comprising data representing total reflection (R) as function of incidence angle (θ), for, respectively, a transmission grating implemented without MLD (e.g., having morphology similar to the morphology 1100 of FIG. 11, but without the MLD structure thereof—that is, the multi-layer structure 1120) and a transmission grating with MLD (e.g., having morphology similar to the morphology 1100 of FIG. 11). In particular, each of plots 2100 and 2110 comprises data representing total reflection (R), for two polarization components (p-polarization and s-polarization), as function(s) of incidence angle (θ).

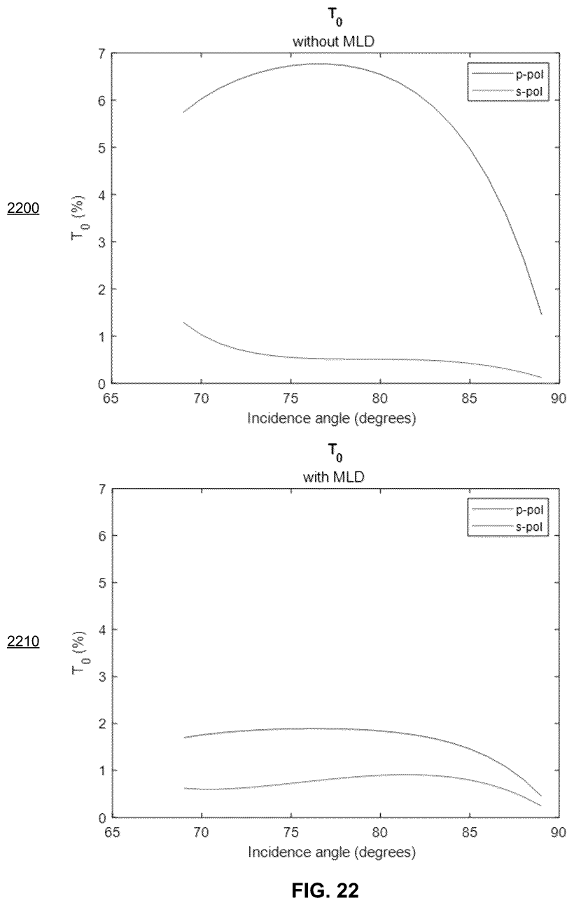

FIG. 22 is a plot illustrating zero-order transmittance (T₀) as a function of incidence angle for example transmission gratings. Shown in FIG. 22 are plots 2200 and 2210, comprising data representing zero-order transmittance (T₀) as function of incidence angle (θ), for, respectively, a transmission grating implemented without MLD (e.g., having morphology similar to the morphology 1100 of FIG. 11, but without the MLD structure thereof—that is, the multi-layer structure 1120) and a transmission grating with MLD (e.g., having morphology similar to the morphology 1100 of FIG. 11). In particular, each of plots 2200 and 2210 comprises data representing zero-order transmittance (T₀), for two polarization components (p-polarization and s-polarization), as function(s) of incidence angle (θ).

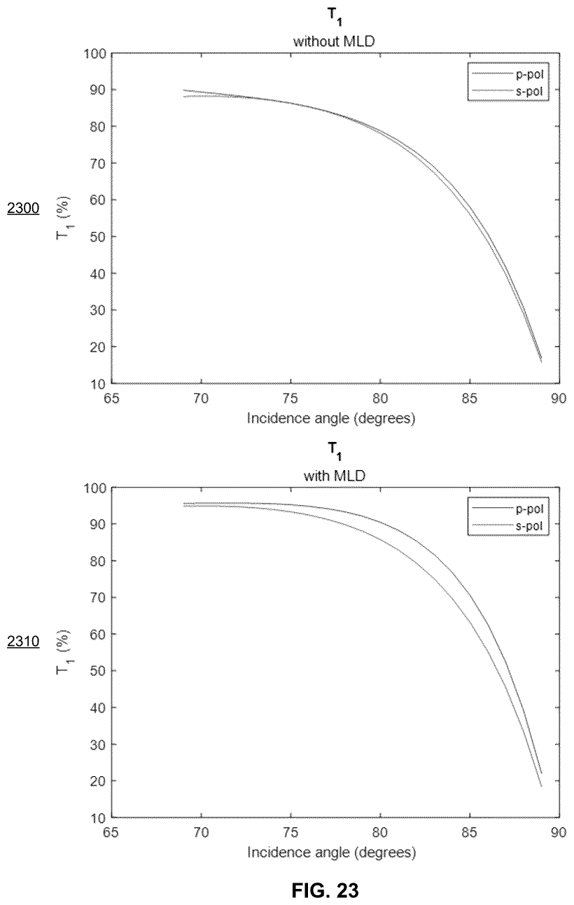

FIG. 23 is a plot illustrating first-order transmitted diffraction efficiency (T₁) as a function of incidence angle for example transmission gratings. Shown in FIG. 23 are plots 2300 and 2310, comprising data representing first-order transmitted diffraction efficiency (T₁) as function of incidence angle (θ), for, respectively, a transmission grating implemented without MLD (e.g., having morphology similar to the morphology 1100 of FIG. 11, but without the MLD structure thereof—that is, the multi-layer structure 1120) and a transmission grating with MLD (e.g., having morphology similar to the morphology 1100 of FIG. 11). In particular, each of plots 2300 and 2310 comprises data representing first-order transmitted diffraction efficiency (T₁), for two polarization components (p-polarization and s-polarization), as function(s) of incidence angle (θ).

As illustrated by the plots in FIGS. 19-23, the inclusion of an MLD structure in transmission gratings improves performance, with respect to the various output orders, and for both polarizations (p-polarization and s-polarization), when assessed based on the incidence angle.

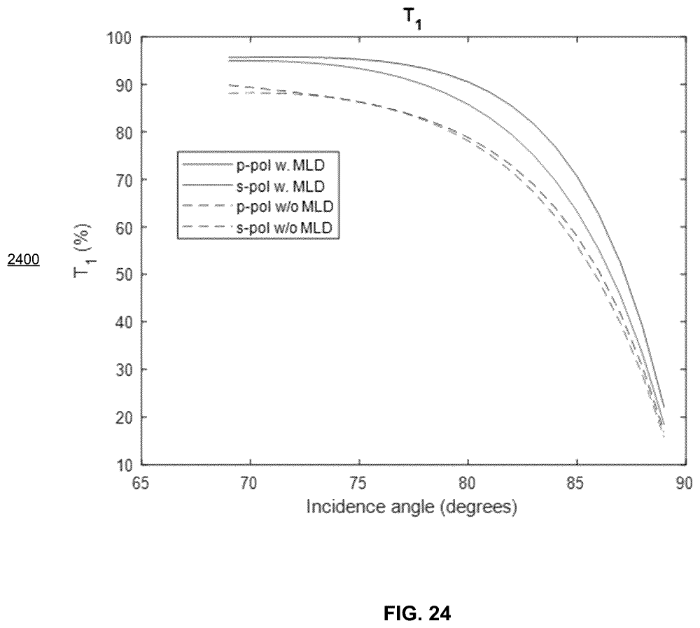

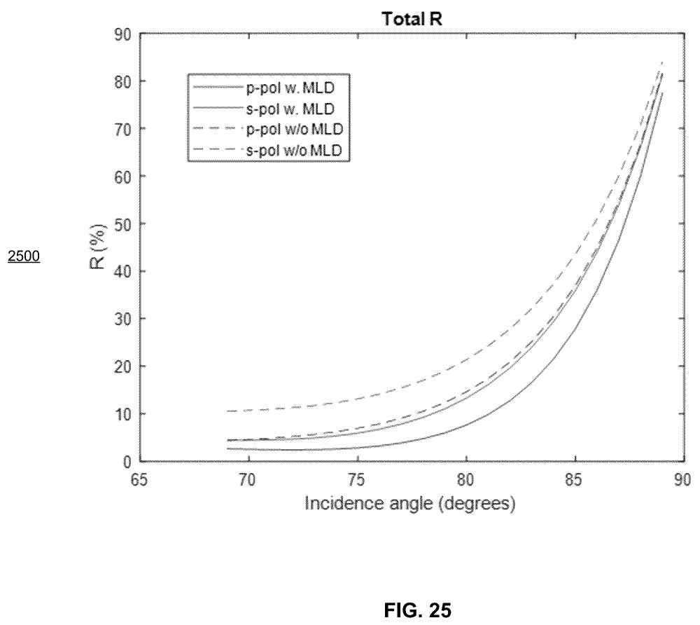

The angular range explored and illustrated in the plots is chosen to conserve the number of allowed orders. For easier comparison, the results with and without MLD structures are plotted together for T₁ and total R, as illustrated in and described with respect to FIGS. 24-25.

FIG. 24 is a plot illustrating first-order transmitted diffraction efficiency (T₁) performance for example transmission gratings with MLD and without MLD. Shown in FIG. 24 is plot 2400, comprising data representing first-order transmitted diffraction efficiency (T₁) as function of incidence angle (θ), for, respectively, a transmission grating implemented without MLD (e.g., having morphology similar to the morphology 1100 of FIG. 11, but without the MLD structure thereof—that is, the multi-layer structure 1120) and a transmission grating with MLD (e.g., having morphology similar to the morphology 1100 of FIG. 11), and for two polarization components (p-polarization and s-polarization), as function(s) of incidence angle (θ).

As shown in plot 2400, although the efficiency into T₁ drops with increasing incidence angle in all cases, the performance across the entire angular range is higher for transmission grating with the MLD structure compared to similar transmission grating (e.g., comprising similar components and structure) but without the MLD structure.

FIG. 25 is a plot illustrating total reflectivity (R) performance for example transmission gratings with MLD and without MLD. Shown in FIG. 25 is plot 2500, comprising data representing total reflectivity (R) as function of incidence angle (θ), for, respectively, a transmission grating implemented without MLD (e.g., having morphology similar to the morphology 1100 of FIG. 11, but without the MLD structure thereof—that is, the multi-layer structure 1120) and a transmission grating with MLD (e.g., having morphology similar to the morphology 1100 of FIG. 11), and for two polarization components (p-polarization and s-polarization), as function(s) of incidence angle (θ).

As shown in plot 2500, although the total reflection becomes large in all cases as the incidence angle approaches 90°, the total reflectivity for both polarizations is strictly less for transmission grating with the MLD structure compared to similar transmission grating (e.g., comprising similar components and structure) but without the MLD structure, across the entire angular range explored.

An example immersion grating based morphology, based on the present disclosure, comprises a plurality of grating lines; an intermediate multi-layer structure; and a substrate bearing both of the plurality of grating lines and the intermediate multi-layer structure; where the intermediate multi-layer structure comprises a plurality of intermediate layers; where at least two of the plurality of intermediate layers comprise different refractive index (RI) material; and where the intermediate multi-layer structure improves performance of the immersion grating based on predetermined performance criteria, where the performance criteria comprises one or more parameters or conditions relating to reflective losses of the immersion grating, and where the one or more parameters or conditions relating to the reflective losses comprises prohibiting at least some of transmitted orders for input beam applied beyond critical angle of the substrate.

In an example embodiment, the plurality of intermediate layers comprises a plurality of dielectric layers.

In an example embodiment, the plurality of intermediate layers comprises one or more layers comprising a first refractive index (RI) material and one or more layers comprising a second refractive index (RI) material, where the first refractive index (RI) material and the second refractive index (RI) material are different.

low refractive index (RI) material and the second refractive index (RI) material comprises high refractive index (RI) material.

In an example embodiment, the one or more layers comprising the first refractive index (RI) material and one or more layers comprising the second refractive index (RI) material are arranged in an alternating manner.

In an example embodiment, the first refractive index (RI) material comprises silicon dioxide (SiO₂).

In an example embodiment, the second refractive index (RI) material comprises tantalum pentoxide (Ta₂O₅).

In an example embodiment, each of the plurality of grating lines comprises a single grating layer.

In an example embodiment, each of the plurality of grating lines comprises silicon (Si).

In an example embodiment, the substrate comprises glass based material.

In an example embodiment, one or more morphology parameters or characteristics of the immersion grating based morphology are set or adjusted to meet the predetermined performance criteria.

In an example embodiment, the one or more morphology parameters or characteristics comprise one or more of line height of plurality of grating lines, line width of the plurality of grating lines, period of the plurality of grating lines, duty cycle of the plurality of grating lines, selection of material used in the plurality of grating lines, number of layers in the plurality of intermediate layers, thickness of each of the plurality of intermediate layers, and selection of material used in each of the plurality of intermediate layers.

An example transmission grating based morphology, based on the present disclosure, comprises a plurality of grating lines; an intermediate multi-layer structure; and a substrate bearing both of the plurality of grating lines and the intermediate multi-layer structure; where the intermediate multi-layer structure comprises a plurality of intermediate layers; where at least two of the plurality of intermediate layers comprise different refractive index (RI) material; and where the intermediate multi-layer structure improves performance of the transmission grating based on predetermined performance criteria, where the performance criteria comprises one or more parameters or conditions relating to reflective losses of the transmission grating, and where the one or more parameters or conditions relating to the reflective losses comprises prohibiting for an input beam applied onto the transmission grating, all outputs beyond first order transmitted orders and first order reflective orders (or, alternatively, all outputs beyond zero order transmitted order, zero order reflected order, first order transmitted orders and first order reflective orders).

In an example embodiment, the plurality of intermediate layers comprises a plurality of dielectric layers.

In an example embodiment, the plurality of intermediate layers comprises one or more layers comprising a first refractive index (RI) material and one or more layers comprising a second refractive index (RI) material, where the first refractive index (RI) material and the second refractive index (RI) material are different.

In an example embodiment, the first refractive index (RI) material comprises low refractive index (RI) material and the second refractive index (RI) material comprises high refractive index (RI) material.

In an example embodiment, the one or more layers comprising the first refractive index (RI) material and one or more layers comprising the second refractive index (RI) material are arranged in an alternating manner.

In an example embodiment, the first refractive index (RI) material comprises silicon dioxide (SiO₂).

In an example embodiment, the second refractive index (RI) material comprises titanium dioxide (TiO₂).

In an example embodiment, one or more of the plurality of grating lines comprise a plurality of grating layers.

In an example embodiment, the plurality of grating layers comprises one or more layers comprising a first refractive index (RI) material and one or more layers comprising a second refractive index (RI) material, where the first refractive index (RI) material and the second refractive index (RI) material are different.

In an example embodiment, the first refractive index (RI) material comprises high refractive index (RI) material and the second refractive index (RI) material comprises low refractive index (RI) material.

In an example embodiment, the one or more layers comprising the first refractive index (RI) material and one or more layers comprising the second refractive index (RI) material are arranged in alternating manner.

In an example embodiment, the first refractive index (RI) material comprises silicon (Si).

In an example embodiment, the second refractive index (RI) material comprises silicon dioxide (SiO₂).

In an example embodiment, the substrate comprises fused silica based material.

In an example embodiment, one or more morphology parameters or characteristics of the transmission grating based morphology are set or adjusted to meet the predetermined performance criteria.

In an example embodiment, the one or more morphology parameters or characteristics comprise one or more of line height of plurality of grating lines, line width of the plurality of grating lines, period of the plurality of grating lines, duty cycle of the plurality of grating lines, selection of material used in the plurality of grating lines, number of layers in a plurality of grating layers used in one or more grating lines, thickness of each of the plurality of grating layers, selection of material used in each of the plurality of grating layers, number of layers in the plurality of intermediate layers, thickness of each of the plurality of intermediate layers, and selection of material used in each of the plurality of intermediate layers.

As utilized herein, “and/or” means any one or more of the items in the list joined by “and/or”. As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y and/or z” means “one or more of x, y, and z.” As utilized herein, the term “exemplary” means serving as a non-limiting example, instance, or illustration. As utilized herein, the terms “for example” and “e.g.” set off lists of one or more non-limiting examples, instances, or illustrations.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. Therefore, it is intended that the present method and/or system not be limited to the particular implementations disclosed, but that the present method and/or system will include all implementations falling within the scope of the appended claims.

What is claimed is:

1. An immersion grating based morphology comprising:
a plurality of grating lines;
an intermediate multi-layer structure; and
a substrate bearing both of the plurality of grating lines and the intermediate multi-layer structure;
wherein the intermediate multi-layer structure comprises a plurality of intermediate layers;
wherein at least two of the plurality of intermediate layers comprise different refractive index (RI) material; and
wherein the intermediate multi-layer structure improves performance of the immersion grating based on predetermined performance criteria, wherein the performance criteria comprises one or more parameters or conditions relating to reflective losses of the immersion grating, and wherein the one or more parameters or conditions relating to the reflective losses comprise prohibiting at least some of transmitted orders for an input beam applied beyond critical angle of the substrate.

2. The immersion grating based morphology according to claim 1, wherein the plurality of intermediate layers comprises a plurality of dielectric layers.

3. The immersion grating based morphology according to claim 1, wherein the plurality of intermediate layers comprises one or more layers comprising a first refractive index (RI) material and one or more layers comprising a second refractive index (RI) material, and wherein the first refractive index (RI) material and the second refractive index (RI) material are different.

4. The immersion grating based morphology according to claim 3, wherein the first refractive index (RI) material comprises a low refractive index (RI) material and the second refractive index (RI) material comprises a high refractive index (RI) material.

5. The immersion grating based morphology according to claim 3, wherein the one or more layers comprising the first refractive index (RI) material and one or more layers comprising the second refractive index (RI) material are arranged in an alternating manner.

6. The immersion grating based morphology according to claim 3, wherein the first refractive index (RI) material comprises silicon dioxide (SiO₂).

7. The immersion grating based morphology according to claim 3, wherein the second refractive index (RI) material comprises tantalum pentoxide (Ta₂O₅).

8. The immersion grating based morphology according to claim 1, wherein each of the plurality of grating lines comprises a single grating layer.

9. The immersion grating based morphology according to claim 1, wherein each of the plurality of grating lines comprises silicon (Si).

10. The immersion grating based morphology according to claim 1, wherein the substrate comprises glass based material.

11. The immersion grating based morphology according to claim 1, wherein one or more morphology parameters or characteristics of the immersion grating based morphology are set or adjusted to meet the predetermined performance criteria.

12. The immersion grating based morphology according to claim 11, wherein the one or more morphology parameters or characteristics comprise one or more of:
line height of the plurality of grating lines,
line width of the plurality of grating lines,
period of the plurality of grating lines,
duty cycle of the plurality of grating lines,
selection of material used in the plurality of grating lines,
number of layers in the plurality of intermediate layers,
thickness of each of the plurality of intermediate layers, and
selection of material used in each of the plurality of intermediate layers.

13. A transmission grating based morphology comprising:
a plurality of grating lines;
an intermediate multi-layer structure; and
a substrate bearing both of the plurality of grating lines and the intermediate multi-layer structure;
wherein the intermediate multi-layer structure comprises a plurality of intermediate layers;
wherein at least two of the plurality of intermediate layers comprise different refractive index (RI) material; and
wherein the intermediate multi-layer structure improves performance of the transmission grating based on predetermined performance criteria, wherein the performance criteria comprising one or more parameters or conditions relating to reflective losses of the transmission grating, and wherein the one or more parameters or conditions relating to the reflective losses comprises prohibiting for an input beam applied onto the transmission grating, all outputs beyond first order transmitted orders and first order reflective orders.

14. The transmission grating based morphology according to claim 13, wherein the plurality of intermediate layers comprises a plurality of dielectric layers.

15. The transmission grating based morphology according to claim 13, wherein the plurality of intermediate layers comprises one or more layers comprising a first refractive index (RI) material and one or more layers comprising a second refractive index (RI) material, and wherein the first refractive index (RI) material and the second refractive index (RI) material are different.

16. The transmission grating based morphology according to claim 15, wherein the first refractive index (RI) material comprises a low refractive index (RI) material and the second refractive index (RI) material comprises a high refractive index (RI) material.

17. The transmission grating based morphology according to claim 15, wherein the one or more layers comprising the first refractive index (RI) material and one or more layers comprising the second refractive index (RI) material are arranged in alternating manner.

18. The transmission grating based morphology according to claim 15, wherein the first refractive index (RI) material comprises silicon dioxide (SiO₂).

19. The transmission grating based morphology according to claim 15, wherein the second refractive index (RI) material comprises titanium dioxide (TiO₂).

20. The transmission grating based morphology according to claim 13, wherein one or more of the plurality of grating lines comprise a plurality of grating layers.

21. The transmission grating based morphology according to claim 20, wherein the plurality of grating layers comprises one or more layers comprising a first refractive index (RI) material and one or more layers comprising a second refractive index (RI) material, and wherein the first refractive index (RI) material and the second refractive index (RI) material are different.

22. The transmission grating based morphology according to claim 21, wherein the first refractive index (RI) material comprises a high refractive index (RI) material and the second refractive index (RI) material comprises a low refractive index (RI) material.

23. The transmission grating based morphology according to claim 21, wherein the one or more layers comprising the first refractive index (RI) material and one or more layers comprising the second refractive index (RI) material are arranged in alternating manner.

24. The transmission grating based morphology according to claim 21, wherein the first refractive index (RI) material comprises silicon (Si).

25. The transmission grating based morphology according to claim 21, wherein the second refractive index (RI) material comprises silicon dioxide (SiO₂).

26. The transmission grating based morphology according to claim 13, wherein the substrate comprises fused silica based material.

27. The transmission grating based morphology according to claim 13, wherein one or more morphology parameters or characteristics of the transmission grating based morphology are set or adjusted to meet the predetermined performance criteria.

28. The transmission grating based morphology according to claim 27, wherein the one or more morphology parameters or characteristics comprise one or more of:
line height of the plurality of grating lines,
line width of the plurality of grating lines,
period of the plurality of grating lines,
duty cycle of the plurality of grating lines,
selection of material used in the plurality of grating lines,
number of layers in a plurality of grating layers used in one or more grating lines,
thickness of each of the plurality of grating layers,
selection of material used in each of the plurality of grating layers,
number of layers in the plurality of intermediate layers,
thickness of each of the plurality of intermediate layers, and
selection of material used in each of the plurality of intermediate layers.
